(19) United States
(12) Patent Application Publication
(10) Pub. No.: US 2026/0359520 A1
(43) Pub. Date: Nov. 12, 2026

(54) SYSTEMS AND METHODS FOR AUTOMATED ARRANGEMENT OF ROBOTIC ELEMENTS

(71) Applicant: AUTOMI TECH PTY LTD, St. Leonards, New South Wales (AU)

(72) Inventors: Vinesh V. GEORGE, St Leonards, New South Wales (DE); Paul B. RAMIREZ, Macgregor, Queensland (AU)

(73) Assignee: AUTOMI TECH PTY LTD, St. Leonards, New South Wales (AU)

(21) Appl. No.: 19/133,040

(22) PCT Filed: Nov. 28, 2023
(86) PCT No.: PCT/IB2023/061947

§ 371 Date: May 27, 2025

(30) Foreign Application Priority Data
Nov. 28, 2022 (AU) 2022903602

(51) Int. Cl. G06F 30/27; G06F 111/04; G06F 111/20; G06F 113/20

(52) U.S. Cl. CPC G06F 30/27; G06F 2111/04; G06F 2111/20; G06F 2113/20

(57) ABSTRACT

There is provided systems and methods for generating an object. The method for generating an object includes: extracting initialisation data from at least one data source; extracting and parsing data from at least one database to define control data; generating actionable metadata from the initialisation data and the control data; determining at least one object component from the initialisation data; generating at least one robotic element corresponding to the at least one object component, the at least one robotic element having attribute data; identifying actionable metadata that applies to the at least one robotic element; applying the actionable metadata to the at least one robotic element; and arranging the at least one robotic element within a prescribed area based on the actionable metadata and attribute data, thereby to generate the object, wherein the at least one robotic element arranges itself autonomously.

### CROSS-REFERENCE TO RELATED PATENT APPLICATIONS

This U.S. Non-Provisional Patent Application is a U.S. National Stage Application under 35 U.S.C. § 371 of PCT Application No. PCT/IB2023/061947, filed on Nov. 28, 2023, which claims priority from Australian Patent Application No. 2022903602, filed on Nov. 28, 2022, the entire disclosures of all of which are hereby incorporated by reference herein, for all purposes.

### FIELD OF THE INVENTION

The present invention relates to systems and methods for the automated arrangement of elements in a prescribed area. More particularly, the invention relates to systems and methods for automated arrangement of elements to generate a design object.

The invention has been developed primarily for use as a system to generate a design object in the form of packaging and labelling for products. Some embodiments of the invention relate to generating designs for packaging of products within regulated industries. While some embodiments will be described herein with particular reference to that application, it will be appreciated that the invention is not limited to such a field of use, and is applicable in broader contexts.

### BACKGROUND

The following discussion of the prior art is intended to facilitate an understanding of the invention and to enable the advantages of it to be more fully understood. It should be appreciated, however, that any reference to prior art throughout the specification in no way be considered as an admission that such art is widely known or forms part of the common general knowledge in the field.

Design of product packaging is a complex process, often incorporating a number of factors including branding and design considerations, meeting regulatory and regional requirements, and distribution rules and guidelines. Each year, organisations produce millions of products globally that are, in many instances, within highly regulated industries such as pharmaceutical, healthcare and food. Each container, label or printed packing material varies in package size, shape and content due to the intended distribution channel, design rules, manufacturing constraints and regulation rules that differ from jurisdiction to jurisdiction. In the context of designing packaging for pharmaceutical products, the design of the packaging can be very specific, and one product may require multiple different packaging designs for different circumstances in which the product is used and/or sold. For example, a product being sold in a pharmacy may require different packaging or labelling to that being sold in a supermarket, a product being used in a clinical trial may require different packaging or labelling to that being sold commercially, and a product being sold in Australia may require different packaging or labelling to that being sold in Europe.

Conventional methods for creating designs for product packaging are based on template systems. These systems require users to select a template, upload the specific required branding, labelling, and the like, and then manually adjust the elements within the template in accordance with the required format to meet particular requirements. Creating designs for packaging of products to be compliant with regulatory, production, brand, design and distribution obligations can be burdensome and time-consuming. Meeting such a broad range of attributes and requirements for design results in increased human resources and increased cost, becoming a major task for companies to produce compliant packaging for a single product. Pre-loaded templates constrain the user input, design of the packaging, and are not amenable to flexibility, where individual templates would be required for differing products, regions and regulatory requirements. Further, designs which require user input are subject to human error in selecting and arranging elements. One hundred percent compliance through human agents is not possible, and the potential for human error is additive in the many steps involved in the current manual template-based processes.

It is an object of the present invention to overcome or ameliorate at least one of the disadvantages of the prior art, or to provide a useful alternative. Embodiments of the present invention have been designed to ameliorate the restrictions of existing systems by ensuring compliance on data entry, validation of provided information, and maintenance of compliance to design controls through the design process. Additionally, in its approach to generating a design, the system provides a decentralisation of decisions to individual robotic elements, giving value to the relational communication between the elements. This is unique compared with existing manual processing that requires a human controller to generate the design.

### SUMMARY OF THE INVENTION

According to a first aspect of the invention, there is provided a method for generating an object, including: extracting initialisation data from at least one data source; extracting and parsing data from at least one database to define control data; generating actionable metadata from the initialisation data and the control data; determining at least one object component from the initialisation data; generating at least one robotic element corresponding to the at least one object component, the at least one robotic element having attribute data; identifying actionable metadata that applies to the at least one robotic element; applying the actionable metadata to the at least one robotic element; arranging the at least one robotic element within a prescribed area based on the actionable metadata and attribute data, thereby to generate the object, wherein the at least one robotic element arranges itself autonomously.

In a preferred embodiment, a plurality of object components are determined from the initialisation data. Preferably, a plurality of robotic elements corresponding to the plurality of object components are generated, wherein each of the plurality of robotic elements has attribute data;

Preferably, a prescribed area forms at least part of the design object. More preferably, the prescribed area is defined by a substantially polygon shape.

In a preferred embodiment, generating actionable metadata includes combining and transforming the initialisation data and control data into a common transformational language. Preferably, the method further including the step of determining a manifest of the at least one robotic element generated for the object.

The control data preferably includes control parameters and/or constraints relating to the object or the at least one robotic element. More preferably, the control data includes at least one of relational data, hierarchy data, regulatory data, rules data, guideline data, historical data, and previous selection data.

In a preferred embodiment, the actionable metadata includes a plurality of actionable metadata points. Preferably, at least part of the attribute data is formed from the initialisation information.

Preferably, the method further includes the step of extracting historical data from a historical database, and including the historical data in the actionable metadata, such that the at least one robotic element may be arranged based on the historical data. More preferably, the method further includes the step of outputting the object.

Preferably, generating the object includes selecting an optimal arrangement of the at least one robotic element. Outputting the object preferably includes selecting an optimal generated object from a plurality of generated objects.

In a preferred embodiment, alternative generated objects having different arrangements of the at least one robotic element are stored in the historical database. In another embodiment, the selection of the optimal arrangement is made by a user, and the user selection is stored in the historical database.

Preferably, attribute data includes at least one of characteristic data, behaviour data, environment data and context data. More preferably, actionable metadata for the at least one related robotic element is applied to the at least one robotic element to enable the at least one robotic element to be context-aware and establish communication with the at least one related robotic element.

The at least one robotic element is preferably configured to reside within the boundaries of one or more prescribed areas. In a preferred embodiment, the at least one robotic element is configured to replicate itself in one or more prescribed areas. In yet further embodiments, the at least one robotic element is configured to communicate with at least one other prescribed area. Preferably, the at least one robotic element includes relational information to enable self-arrangement.

In a preferred embodiment, the relational information includes at least one of hierarchical and/or prioritisation information upon which arrangement actions are executed. Preferably, the at least one robotic element is configured to arrange itself into a localised decision group with at least a second robotic element for self-arrangement. More preferably, the at least one robotic element is configured to perform mutations to enable self-arrangement within the prescribed area.

In a further embodiment, mutations are performed based on at least a portion of the actionable metadata.

In accordance with a second aspect of the invention, there is provided a system for generating an object, including: at least one data source from which initialisation data may be extracted; at least one database; an extraction unit, configured to extract and parse data from the at least one database to define control data; a metadata unit in communication with the at least one database and the at least one data source, configured to generate actionable metadata from the initialisation data and the control data; an element creation engine, configured to determine at least one object component from the initialisation data and create at least one robotic element corresponding to the at least one object component, the at least one robotic element having attribute data; wherein the metadata unit is configured to identify the actionable metadata that applies to the at least one robotic element, and apply said actionable metadata to the at least one robotic element; and an arrangement engine in communication with the at least one robotic element, configured to enable the at least one robotic element to arrange itself autonomously within a prescribed area based on the actionable metadata and attribute data; and an object generation engine, configured to generate the object after arrangement of the at least one robotic element.

### BRIEF DESCRIPTION OF THE DRAWINGS

Preferred embodiments of the disclosure will now be described, by way of example only, with reference to the accompanying drawings in which:

FIG. 1 is a diagram of the components of the system according to one embodiment of the invention;

FIG. 2 is a diagram showing the hierarchy of robotic elements according to one embodiment of the invention;

FIG. 3 is a diagram showing the robotic elements, according to one embodiment of the invention, in a prescribed area and within localized decision groups;

FIG. 4 is a diagram showing the robotic elements, according to one embodiment of the invention, communicating across prescribed areas;

FIG. 5 is a diagram outlining the components of an actlet, according to one embodiment of the invention;

FIG. 6 is a flow diagram showing the process of robotic element generation, according to one embodiment of the invention;

FIG. 7 is a flow diagram showing the process of a single mutation of a robotic element, according to one embodiment of the invention;

FIG. 8 is a flow diagram showing the process of performing heuristic and compliance driven decisions according to one embodiment of the invention; and

FIG. 9 is a system schematic diagram showing a form of learning and feedback of the system according to one embodiment of the invention.

### DETAILED DESCRIPTION

### System Overview

The systems and methods described herein relate to automating the arrangement of elements within a prescribed area, without the use of specific input locational commands, or the use of template systems, that meet design object requirements including, but not limited to regulatory compliance, design principles, brand guidelines, and production requirements. In some embodiments, the system is able to generate packaging and labelling for products that is up to 100% compliant with defined regulatory, production, brand, design and distribution data. For example, generating packaging that is compliant with defined rules relating to categories such as regulatory, production, brand, design and distribution channel requirements.

The system and methods of the present invention enable each unique element in a design object to know where it is placed within the context of the object, and the behaviours and relations connected to that context. This allows each element to “act” within a social hierarchy, collectively along with the other elements. Together, these elements can arrange themselves into suitable units. In addition to the relational construction of the design object, each of the elements improve the collective knowledge of what is preferred for the design object under certain conditions and constraints.

FIG. 1 is a diagram showing components of the system according one embodiment of the present invention. The system of the present invention may be referred to as a “Robotically Generated Object Engine (RGOE) system” or an “RGOE”. The core RGOE system implements the automated arrangement of elements within a prescribed area. The RGOE system is used for intelligently generating elements within specific controlled environments. For example, it can be used to generate packaging and labelling for a product that is compliant with all regulatory, design, and production requirements. As shown in FIG. 1, the RGOE system includes a number of sub-systems. The subsystems may include at least a control data subsystem (also referred to as a codex) and/or a common transformational language (CTL) subsystem. In some embodiments, these subsystems may be included in a reference unit. The subsystems may further include at least an Active Robotic Core Origination (ARCO) unit, a robotic element, and/or an active playspace unit (which defines the prescribed area). In some embodiments, these subsystems may be included in a robotic unit. In some embodiments of the invention, the system may further include a Human Robotic Co-Learning (HRCL) unit, and/or a Heuristic Compliance Driven Decision (HCDD) unit. In some embodiments, these subsystems may be included in a reasoning unit.

The RGOE is not a conventional template-based system, where template positions are used to neatly define outcomes, whilst only allowing for some slight variation for additional, related or differing products. In contrast to conventional systems, one of the RGOE's technical advantages is in providing learned design object solutions that do not require templates. However, it will be appreciated that the RGOE system may have the ability to utilise template layouts to provide a framework or starting point for element arrangement, if required. For example, a template or scaffold may be proposed to the system as a framework for new potential design objects in a human-robotic hybrid design model. In some embodiments, a defined framework may be fed into the system to provide defined types of design objects. For example, to define a design object type of packaging, brochure, presentation, website, or the like. In other embodiments, defined frameworks for design objects may be used to define sub-areas within which elements may arrange themselves.

The system works by creating a robotic element for each design component to be included in the design object. Each robotic element is created and exists virtually within a prescribed area, environment, or a playspace that defines at least one sub-area of the design object. The robotic element may also be referred to herein as an Automated Vector Element Robotic (AVER). The system utilises a Common Transformational Language for communication between the robotic elements. In some embodiments, the common transformational language may include an Actionable Metadata Language (AAML). In the preferred embodiment, the Common Transformational Language is the AAML. Relevant AAML is applied to each robotic element. The language characterises each robotic element and provides context information relating to the current attributes of the robotic element. It may also provide attribute information. In some embodiments, the context information may additionally relate to the future attributes of a robotic element. The information populating the context information and/or attribute data for each robotic element is derived from processing control data stored in the codex. In some embodiments, for example, where the system is generating a design object related to product packaging, the control data may include processing various regulatory, design and production sources stored in the codex.

In one embodiment, the system includes at least one data source configured to provide initialisation data. This data source may include any appropriate source from which data relating to the design object may be extracted, but is not limited to, a user request, a file such as a document (for example, a product brief document), an online form, a database, an API, and/or a table. In some embodiments, the initialisation data may be stored in an external database before being used by the system. In other cases, the initialisation data is provided directly to the system.

The system further includes at least one database. The at least one database may be referred to herein as the codex. The database may include data relating to constraints, controls, regulations, boundaries and parameters which are applicable to and/or affect the behaviour of a robotic element. In some cases, the system may include a plurality of databases. Alternatively, the system may extract control data from at least one secondary data source, which may include a file or document. In further embodiments, the at least one database includes a plurality of secondary databases and/or secondary documents from which the data is extracted. An extraction unit extracts, transforms and parses the data from the at least one database to define control data. The control data forms the codex. In further embodiments, the system is configured to extract data from a plurality of databases. These may be a part of the system, or they may be external to the system. The system may also include a historical database from which data may be extracted and transformed into control data. The system uses a common transformational language, to transform the control data into a standard reference, allowing the codex to maintain a specific reference to the original source of the data (for example, which database or document it came from).

Embodiments of the system further include a metadata unit in communication with the at least one database and the at least one data source, configured to generate actionable metadata from the initialisation data and the control data. Actionable metadata is derived from the control data combined with initialisation data. The system then uses an element creation engine to determine, from the initialisation data, at least one design component relating to the design object. The element creation engine is then able to create at least one robotic element corresponding to the at least one design component. The generated robotic element is generated with attribute data. The attribute data may come from the initialisation data, or from the codex. The metadata unit is configured to identify the actionable metadata that applies to the at least one robotic element, and apply said actionable metadata to the at least one robotic element. In some cases, the relevant actionable metadata may be determined at least in part on the attribute data of the robotic element.

The system further includes an arrangement engine in communication with the at least one robotic element, configured to enable the at least one robotic element to arrange itself autonomously within a prescribed area based on the actionable metadata and attribute data. That is, the robotic elements are able to self-arrange into an optimal design object which is compliant with requirements. The process of self-arrangement includes making iterative mutations to an individual robotic element within the context of the design object. It may also make these mutations in the context of relationships with the other robotic elements. Mutations may also be made on the basis of the behaviour of other robotic elements. That is, a robotic element may be affected by an external factor and perform self-arrangement accordingly. The system then uses an object generation engine to generate the design object after the robotic elements have self-arranged. In some embodiments, the object generation engine is configured to select an optimal design object from a plurality of generated design objects which meet the design requirements. Alternatives may be stored in the historical database.

The system can automatically determine at least one alternative option for a design object that meets defined requirements. In some embodiments, the system may determine a plurality of alternative options for design objects which meet defined requirements. In an example embodiment, the system may generate a number of compliant designs for the label or packaging appropriate for use in a specific geographic region or distribution channel. By being able to automatically generate the design object, the system provides the technical advantages of simplifying design object variations and the finishing process, reducing human resources (such as the time it takes to go through various channels to obtain approvals), and improves the throughput in a supply chain from initialisation to end product.

The design object generated by the system is ready to use. In some embodiments, the design object may be ready to use in a digital form, such as website design. In other embodiments, the design objection may be in a print-ready form. For example, it may be in a form of a file for a packaging design that can be sent straight to a printer for manufacture. The generated design object is able to be consistent and reliable, and may employ standards and consistency across a number of related or variation products.

By automating the generation of the design object, the probability of operator error is also substantially eliminated. The system's utilisation of robotic elements to automatically arrange themselves within a prescribed area and control data means that no human input is required in the generation of the object. Users of the system will not need to have a comprehensive knowledge of requirements for the design object. For example, for pharmaceutical packaging, there is no need to have the knowledge of regulation or brand guidelines beyond the limited ability of particular applications or systems associated with labelling. For example, there may be a need to know that packaging for a pharmaceutical product requires a label identifying the active ingredient, but there is no need for a user to have to input any characteristics or attributes of such a label, or have knowledge of how the requirements regarding the active ingredient packaging differ based on distribution channel (such as pharmacy or supermarket) or jurisdiction (such as country of sale).

The system has the ability to maintain an audit trail as it makes changes or iterations to the design. The changes or iterations may also be referred to herein as decisions or mutations made by each of the robotic elements. The audit trail is automatically maintained, as each decision is written to an audit database in real time as any attributes or characteristics of robotic elements are changed. The audit database may be separate to, part of or in communication with a historical database. Decisions are stored throughout the element arrangement process to allow the system to understand common selections and better positional starting points. In some embodiments, the audit trail may also include user decisions or inputs in relation to the design object. The audit trail enables increased confidence in the resulting object output, and additionally may aid in the approval process for the design. For example, it may aid in compliance approval with regulatory bodies for regulated industries.

The system is further able to determine if elements or data is missing during initialisation of the design object. In some embodiments, it can determine if the design object type is not identified, if there is no product definition or if there is information missing for a particular target or requirement of the design object. For example, during initialisation of the design object, the system can determine if there is not enough information provided to determine whether the product is a pharmaceutical product or a food product. In another example, it may determine that the system does not have enough information about the regulatory requirements related to the display of ingredients for food packaging in Europe. Deficiencies in the initialisation information may be automatically flagged by the system before it proceeds in creating the robotic elements for the design object. Therefore, the system provides the advantage of eliminating the burdensome and time-consuming process of individually determining the necessary label elements and associated data. In some embodiments, the system prevents the robotic elements from being created and/or the design object from being generated once it identifies a deficiency in the initialisation information, thereby improving the use of computer resources by not allowing the unnecessary use of processing resources without the required initiation information. This feature of the system ensures that the generation of the design object will be based on at least the minimum number of required robotic elements to meet the defined requirements, and therefore the efficiency of the design object generation process. In some embodiments of the system, it is not possible to generate a design object which does not comply with the control data and parameters.

### Robotic elements

A robotic element is an intelligent robotic unit that represents a single design component of the design object. The robotic element is created from each unique design component to be used within the design object. A design object may include a plurality of robotic elements. In some embodiments, it is possible for a design object to include at least one robotic element.

The system generates at least one design component as a unique and dynamic robotic element of the design object. For example, in some embodiments related to product packaging, the robotic element may include, but is not limited to, a graphic representation of a product logo, mandatory warning label, product image, a text representation of an active ingredient, and/or background images. In other embodiments, the robotic element may include more than one design component, for example, it may include a number of components, such as a piece of text and a logo. The robotic elements may include, but are not limited to, at least one of: variables, data structures, functions, methods, objects, formats, files, tables, columns, formatting, data and/or graphics, or a combination of any of these.

The robotic element is context-aware, self positioning, self-adjusting and self aligning, and follows a hierarchical or relational order in relation to the behaviour of other robotic elements. Each robotic element is a unique instance, and is assigned to a specific area within the design object.

Each robotic element may contain a plurality of descriptive attributes or characteristics in the form of attribute data. Due to the automated nature of the arrangement of the robotic element, each of the attributes is considered to have a direction and a magnitude. The attribute data is applied to each robotic element when it is created or originated. The attribute data may also include context information. The context information may relate to the current state of the robotic element and/or any of its characteristics, as well as the state of other robotic elements and their respective characteristics within the design object. Each robotic element is enabled to be context-aware through the use of the attribute data. In some embodiments, the attribute data is in the form of an Actionable Metadata Language (AAML). Each robotic element also contains information of the current state of its attributes relevant to the element type that it is. For example, a robotic element in the form of an image may contain attribute data about image-specific attributes such as resolution, original width and height and rotation. Whereas text elements may contain attribute data about text-specific attributes such as font, font size, tracking and kerning.

### Playspace and Decision Groups

The playspace is the physical or virtual space-constrained area that the robotic elements can inhabit. The playspace may also be referred herein as a prescribed area. The playspace may be a predefined area. In other embodiments, the boundaries of the playspace may be changeable based on the actionable metadata or attribute data of the robotic elements. The playspace may refer to the entire design object, or it may refer to only a defined part of the design object. The playspace may refer to at least part of the design object. The design object includes at least one playspace. In preferred embodiments, the design object includes a plurality of playspaces. In some embodiments, the robotic elements may reside only in one playspace. The robotic elements are configured to reside within the boundaries of one or more prescribed areas.

Due to constraints, defined parameters, or control data, the robotic elements may replicate themselves in one or more additional playspaces. This may include replicating itself in an additional playspace, and deleting itself from the original playspace. In some embodiments, playspaces are defined by a polygon. In further embodiments, playspaces have a substantially rectangular shape. In other embodiments, each individual playspace within a design object may be different shapes and sizes.

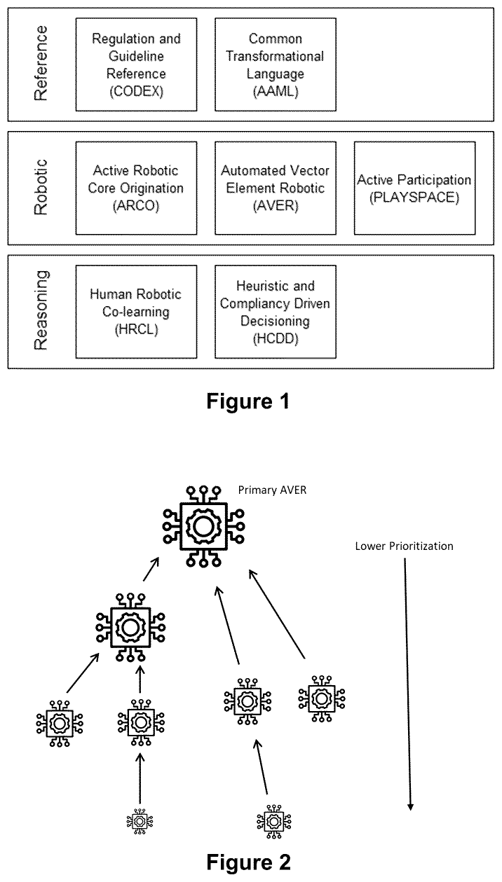

FIG. 2 shows how robotic elements follow a hierarchy and prioritisation level. Identified primary robotic elements have prioritisation over secondary or lower prioritisation elements, thereby forming a hierarchy between the robotic elements. The robotic elements behave and arrange themselves within the context of this hierarchy and relationship. Preference in placement decisions is provided for specific robotic elements, and the order of these preferences may change depending on the actionable data and initialisation information. For example, the preference for individual elements in a product packaging object may change based on product and regulatory environment requirements.

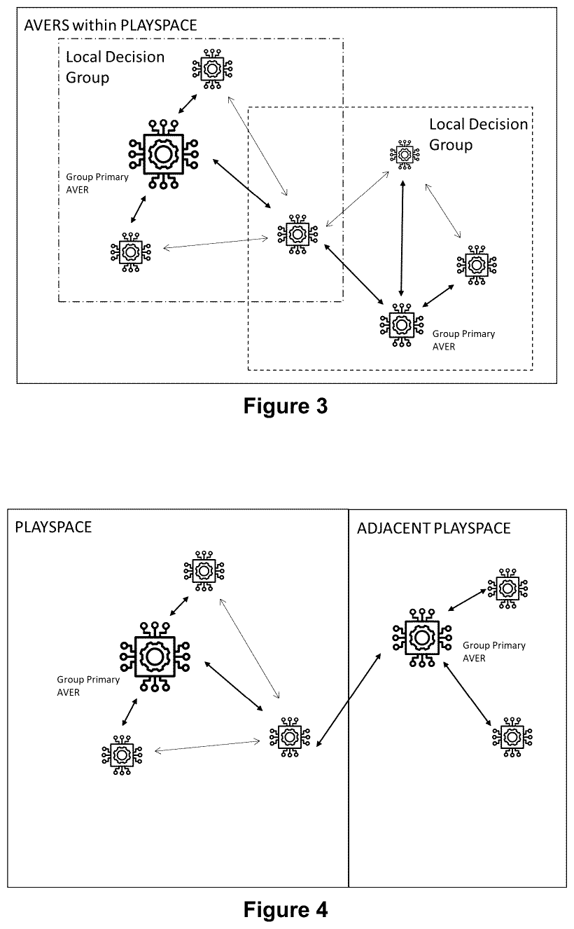

The robotic elements also have the ability to arrange themselves within localised decision groups (LDGs) in a playspace. FIG. 3 demonstrates the robotic elements within a playspace. It shows a number of the robotic elements within localised decision groups within a single playspace. In the example shown in FIG. 3, the robotic elements may arrange themselves into localised decision groups, with the highest priority taking the lead within the localised decision group. In some embodiments, a robotic element may be in one or more localised decision groups. In some embodiments, localised decision groups may include one or more robotic elements in common. The principle of prioritisation occurs when the initial manifest is created, and the robotics elements are initialised with their attributes and playbook.

Localised decision groups are formed from a local position context. The position range that determines nearby robotic elements is configurable and can be changed to suit the nature of the design object being created. Localised decision groups are configurable in the system within a few main criteria, including, but not limited to: 1) proximity to other elements (the proximity distance is also configurable); 2) actionable metadata defined by the AAML relating to defined constraints or parameters; and 3) common elements within the design object requirements, also defined with AAML.

FIG. 4 shows an embodiment in which robotic elements may communicate across to an adjacent playspace. The same engagement principles of robotic element hierarchy and prioritisation apply across playspaces. In some embodiments, a robotic element may be in communication with at least one other robotic element in an adjacent playspace. A robotic element may be in communication with a plurality of robotic elements in an adjacent playspace. It will be appreciated that robotic elements may also communicate across to any other playspace within the design object, and are not necessarily limited to playspaces which are positionally adjacent. Each robotic element may be configured to communicate with at least one other playspace.

### Codex and Actionable Metadata Language (AAML)

The codex is a collection of data. In some embodiments, the codex includes at least one database. This may be referred to as the at least one primary database. Additionally, or alternatively, the codex includes a plurality of primary databases. The codex may extract data from a plurality of databases.

The codex may include initialisation data which is used create the robotic elements. The codex may further include control data. The control data may include control parameters and/or constraint data, which are used to create context information or the attribute data for the robotic elements. Control parameters and/or constraint data may refer to limitations or applications related to the various robotic elements. For example, in one embodiment, this may include data from a number of regulatory standards which define the specific parameters required for particular design components, such as the size of the warning label which appears on a product packaging.

The codex manifests the control parameters into a standard reference. In a preferred embodiment, the codex is a database of translated data and/or information that is tagged with a unique reference to the relevant source of the data. For example, this may include a unique reference to the source document from which the data was extracted.

The technical advantages provided by the codex include that it utilises tokenisation of keywords to more easily identify and extract information. Information is broken up from a sequence of strings into components such as, but not limited to, keywords, individual words, phrases, sentences, symbols or characters to form “tokens”. In some embodiments, tokenisation may include detecting and tagging keywords or phrases, or parts-of-speech. One advantage of using tokenisation is that it allows natural language of input files to be translated into usable data, which is ultimately translated to provide the attribute data and context information upon which the robotic elements can make decisions.

The databases which form the codex are populated with data which can be extracted from existing files. Each relevant line or phrase of a file or document is translated and stored in one or more codex lines. In some embodiments, initialisation data is extracted from an initialisation file and is stored in the database. In some embodiments, the initialisation file is in the form of a product brief. In some embodiments, the initialisation data may be stored in a database which is separate to, but in communication with, the codex. The minimum required set of robotic elements for a particular design object is generated from the codex after the initialisation data has been stored. The codex identifies and verifies the number of robotic elements required for the design object, and creates a list of the elements for the design object. This list may be referred to as an element manifest. In some cases, the element manifest is a list of the elements that are placed within the design object. In other embodiments, the element manifest may be a list of the elements which are placed within a defined sub-area of the design object. For example, the element manifest may list elements which are within a defined sub-area “navigation bar” of a website design, or which are within a defined sub-area “left side” of a packaging design.

When data is extracted from the codex, it is translated into an actional metadata language AAML (Actionable Metadata Language). During the process in which the system generates a design object, a full dataset of AAMLs is produced relevant to the design object. The AAML is effectively a detailed list of data, which contains actionable information relating to one or more robotic elements within the design object. The codex can identify each line of data from its relevant source, and this identification then allows the codex to directly reference each or any of the AAMLs. The AAMLs can then provide a direct link back to the individual data source that is fully referenced.

The AAML is a language specifically designed to enable self-oriented, metadata context based, decision-making, based on constraints and parameters from multiple sources. The language is structured around the robotic element itself and its contained metadata, and how the individual attribute of the robotic element will potentially change, the range of change that could be incurred, the reference element and trigger metadata. A robotic element is context-aware, as at any point in time during arrangement it is aware of the elements in the same defined area. In addition to macro-level context, robotic elements can form local decision groups where context is based on a smaller subset of the robotic elements within a defined area.

The AAML is a form of metadata applied to a robotic element, which characterises the element and provides it with information about its context. The AAML is the common language used between robotic elements to allow relational interaction. It is oriented around actions and behaviours that are possible to be implemented, and contains at least information regarding the actor, actions, action size, triggers and dependencies. That is, the AAML is about what the element can do, or how it can act, with the information about its context. The attribute data applied to a robotic element is created at least based on control data taken from the codex and the translated AAMLs. AAML may also be referred to herein as actionable metadata. The AAML interprets and defines what the element can do with both embedded information (internal information), and the intersection of new information from other elements in the playspace (external information source), in accordance with context of the environment (playspaces) and objects (players).

The AAML is applied to each individual robotic element. Each AAML is specific to an individual attribute or characteristic of the context information. The AAML may be defined into its most minor and non-divisible units called “actlets”. Actlets refer to a distinct action within an AAML restriction. Actlets are lines of data which provide a scope of decisions from which the robotic element can select a modification of its behaviours. Hierarchical and/or prioritised relationships between elements are utilised in the arrangement, whereby each individual element will understand its priority in relation to each of the other robotic elements and is able to adjust its behaviour accordingly. In some embodiments, there is no mechanism for subversive behaviour by any elements against the applied control parameters. The actions defined by actlets in AAML are derived through information and data in the codex combined with initialisation information. The codex maintains the specific reference to the original documents. This metadata then enables the direct connection to the source data and enables documentation of actions taken for creation of an audit trail or traceability purposes.

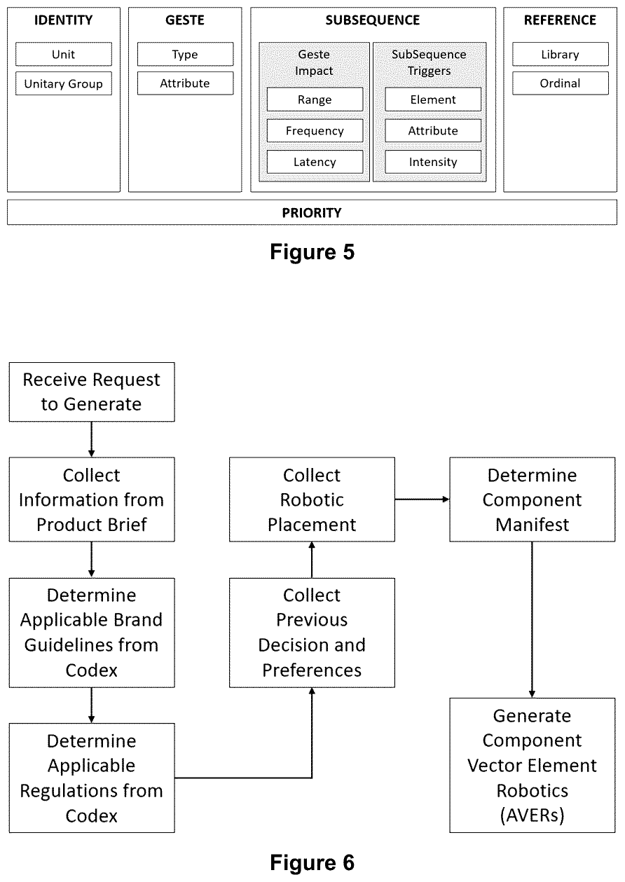

In one embodiment, an actlet is a unitary phrase of the AAML. The structure of an actlet according to one embodiment is shown in FIG. 5. It is defined by a number of attributes:
1) The Identity which is the unitary element or group;
2) the Geste—which is the unit of change action that the unitary unit considers. This may include, but is not limited to, type or attribute of the action;
3) the Subsequence, which consists of the triggering element, and condition and range of attribute value constraints of an action range affecting the unitary unit. This may include, but is not limited to, a geste impact (including, for example, range, frequency, latency) and subsequence triggers (including, for example, element, attribute, intensity).

Each actlet may also have a:
4) relative Priority to other actlets; and
5) Reference to the original source data. This may include, but is not limited to, reference to library data or ordinal data.

However, it will be appreciated that the actlet may have one or more of the above-described attributes. Furthermore, the actlet may also include additional attributes.

A plurality of actlets may be stored together in a data structure. In some embodiments, the data structure may be an array or a list. The data structure may be colloquially referred to as a “playbook”, from which each robotic element is able to read and apply relevant actlets.

Each robotic element possesses attribute information and actionable metadata that lets the element know information relating to at least where it is to be placed, the relations connected to that placement, how it is to be characterised, and how it can interact with other elements. Such attribute information may include any information about characteristics of the design component, or to the environment in which the element is being placed (for example, constraints as to area or placement). Attribute information may include characteristic information, behaviour information, context information, relational information, and/or environment information. Attribute information may include at least size, positioning, contrast, alignment or other associated behaviours. In some embodiments, the attribute information may include information about the behaviour of the element. The attribute information enables the element to self-determine the most optimal characteristics and behaviour. In some embodiments, the optimal characteristics and behaviour of an element is determined based on context variables including at least one of: other elements (and their associated attribute data), environment, and environment for the physical features of the product design. For example, this may include things such as colour bleed on physical materials, accommodation for glue area and run off limitations of printers and the like.

By generating the robotic element with actionable metadata, it allows each element to “act” within a social hierarchy collectively along with the other elements. It recognises the roles and placement of another element in addition to its own. Collectively, each robotic element may also have the explicit ability to arrange themselves into suitable collective units. In some embodiments, collective units may include at least two robotic elements.

AAML enables robotic elements to only be aware of the context necessary in making a decision. This therefore reduces the impact of unnecessary information and noise for each of the robotic elements, thereby increasing the efficiency with which the elements can perform decision-making and take actions to make changes or mutations to achieve optimal arrangement. This technical advantage is effected by only providing each robotic element with the AAML appropriate to itself and any elements it may interact with. It does not need to have the full dataset of AAMLs. The context is provided by the current state of the other robotic elements. In the AAML, the restriction to only appropriate and required information allows correct contextual behaviour for each element.

As an example, in generating a design object in the form of packaging for a food product, the robotic element representing the product name (the “name element”) may be applied on the front of the box packaging. The name element will be provided with its own relevant AAML, as well as the AAML for other robotic elements which may be applied on the front of the box packaging. However, the name element will not require the AAML for the robotic element representing the ingredient list (the ingredient element), which will be restricted to the left side of the box. As the name element and the ingredient element will not interact because they are restricted to distinct areas, they do not require each other's AAML, but are still able to make contextual decisions for their self-arrangement.

### Method of Generating the Object

The core of a robotic element for a design object is generated through an active robotic core origination (ARCO) process. This process collates the initialisation data, as well as control data from the codex to generate the core of each robotic element. The active origination creates the robotic element as an initiation of an individual design component, where the robotic element is created with the information needed for automated arrangement within the design object. Effectively, this information is the robotic elements DNA.

FIG. 6 shows a process diagram of the method of generating a robotic element for a design object, in an example where the design object is a product packaging object. In this example embodiment where product packaging is generated, the method of generating robotic elements for the design object draws on collating relevant product definition information from a product brief and applicable regulations, design, and guideline information from the codex.

In step 1, the origination of the robotic elements is initiated once the initialisation information, which is in the form of a product brief, is entered and completed through a user interface. In some embodiments, this may also be done internally via an API. The product brief information is stored in a primary database. In step 2, the product brief information is extracted from the primary database. A manifest is created by identifying the various design components required for the packaging from the product brief, and the requirements of the packaging design components. In some embodiments, the manifest is created before the actlets are selected, as the manifest determines which unitary elements are required. The manifest includes the robotic elements (including their attribute information) and associated assets (other robotic elements that are packaged together given the context of the use) and asset information (relational information of the robotic elements given the context of their use) to be used in the creation of the packaging object.

In step 3, the manifest is provided to an arrangement engine in a common standard format. In a preferred embodiment, JSON is used as the common standard format. In other embodiments, the common standard format may include, but is not limited to TOML, XML, YAML, HCL, Avro or OData. Based on the robotic elements that will be placed within the design object, and the nature of the surface that the elements will be placed on, control data from the codex is selected that applies to the elements and the elements that they may affect. In this case, control data includes brand guidelines from the codex. The AAML actlets are collated from the codex lines and selected for the specific robotic elements.

In step 4, the same approach as applied in step 3 is applied to further control data from the codes. For example, as shown in the embodiment of FIG. 6, this includes regulations for the packaging from the codex. The codex lines with control data in the form of regulations which are appropriate to that robotic element are selected. In step 5, the ACRO will apply actlets to generate the robotic element. In some embodiments, the ACRO may utilise actlets from previous decisions made by the system by referring to a historical database. In further embodiments, the ACRO may utilise previously selected actlet preferences for each of the robotic elements selected.

In some embodiments, the product brief information may include control data from the codex. After step 1, the system is able to determine whether any initialisation information is missing from a product brief completed by the user, and flag missing information or request further information from the user before it is able to complete the initialisation of the robotic elements, based on information from the codex. In some embodiments, extracting information of the product brief information in step 2 also includes extracting control data from the codex to form the initialisation information. For example, it may include extracting control data in the form of design requirements for at least one design component of the packaging.

The method for generating a design object uses the ARCO process to provide the self-arranging robotic elements. The method of generating an object includes receiving a request to generate the object. The request may be in the form of a product brief, as exampled in FIG. 6, but it will be appreciated that the request may include any form of information related to the type of design object being generated. In some embodiments the request information can be entered by a user through an input dashboard. In other embodiments, the request information may be extracted from an external source. In the preferred embodiment, the system is able to prefill various fields and/or options in the request information when there is prior knowledge. Prior knowledge may include information relating to a specific type of design object (such as a particular product packaging), specific requirement (such as jurisdiction specific regulations), and/or historical decisions or previously generated design objects. The system is able to perform error checks so that the initial data provided in the request is verified. The request is confirmed by the system as compliant with the relevant requirements regarding existence (whether the information has been entered) and content (whether correct information has been entered) prior to the design object being generated. In a preferred embodiment, the request is confirmed by the system prior to the determination of components and generation of robotic elements to allow for deficiencies to be identified early in the process to reduce unnecessary processing. In some embodiments, the request may be sent to a third party for approval before being sent to the system.

Initialisation data is extracted from the request. In some cases, this may be stored in a database. In other cases, the request may be stored in a database before initialisation data is extracted.

Data from at least one secondary database is extracted, transformed and parsed to define control data. The control data is stored in the codex. In some cases, the data may be extracted from a plurality of databases. In other embodiments, the data may be extracted from a single database. Transforming and parsing the data includes tagging the data with a unique reference to the source document from which it is derived. The control data may also include a direct reference to the actionable metadata or AAML with which it is associated. Actionable metadata is then generated from the initialisation data and the control data.

From the initialisation data, design components of the design object are determined in accordance with the request. Robotic elements are then generated for each individual design component. The robotic elements are created with attribute data, which provides information about the characteristics of the element, the state of the characteristics, the environment of the element, and the context of the object. In some embodiments, the attribute data may include hierarchical and/or prioritisation level information.

The actionable metadata that applies to each robotic element is identified and applied to the robotic element. Each robotic element will be provided with the actionable metadata associated with itself, and any other elements that it may be affected by, or which it may affect. For example, a logo (a graphic element type) will be provided with actional metadata associated with the logo (such as resolution, width, and the like) as well as other element types that it may interact with, such as a background image element or a text element. Once applied, the robotic elements are able to arrange themselves autonomously within the context of the object, including a prescribed area, based on the actionable metadata and attribute data. In some embodiments, the robotic elements iteratively mutate across different attribute values within the constraints applied by the actionable metadata to determine the most appropriate mutation to bring the design object into alignment with the initial request and control data, or any other defined requirements. Once arranged in line with the requirements of the request, the design object is generated.

In some embodiments, it may be possible for the robotic elements to arrange themselves in a number of optimal arrangements which meet the requirements of the request. In this case, the system chooses an optimal variation. The optimal variation may be based on historical information, or specified design principles. In some embodiments, a plurality of design objects generated may be output to the user for selection. In other embodiments, the system may prompt the user to select the optimal from a subset of optimised design objects before outputting the final selection. The final design object may be created and automatically output by the system. In other embodiments, the final design object is created and exported on approval from a user.

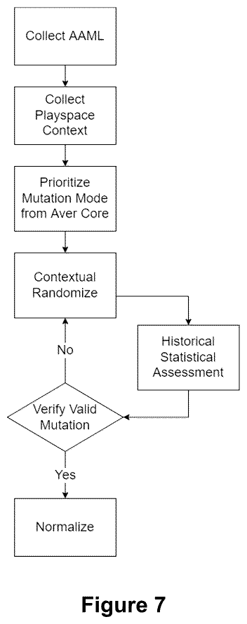

The mutation process is shown in FIG. 7. The relevant AAML is read from the robotic element, and context information about the prescribed are in which the robotic element sits is also collected. A mutation mode is initialised and prioritised for the individual robotic element. A range of options for attribute mutations are then generated. In some embodiments, the degree to which the change to an attribute is applied is randomised in accordance with the context of the robotic element. In some embodiments, an assessment of historical decisions and data from the historical database will be performed to determine the appropriate level of change for the mutation or a range of mutations. The system the verifies whether the mutation is valid. If it is not, the system proceeds to generate another range of options for attribute mutations. If it is valid, the mutation is normalised and applied to the robotic element.

### Robotic Element Heuristics and Compliancy Driven Decisioning (HCDD)

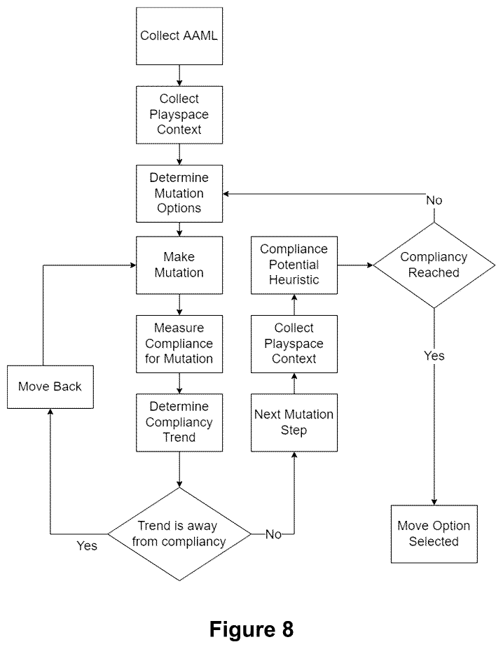

FIG. 8 shows a method of the RGOE making decisions through a hierarchical decision chain that utilises compliance function measures and continues along a decision tree based on compliance measures from the compliance function. This is an example of how the robotic elements arrange themselves.

The RGOE processes a series of mutations. Mutations are a change from the robotic element's current state. Mutations are constrained based on appropriate actlets in the robotic element's collection of AAML.

A mutation is an intelligent choice made of a value from a range of values constrained within the actionable metadata and considered within the element's current conditions. They may be rigid, thus allowing no mutation, or multi-variable (for example, applying a size change, opacity change, and placement value change). The AAML provides a parameter (for example, a range of potential change), and the robotic element autonomously determines the amount of change from its current state. In some embodiments, an arrangement engine considers each alternative change and selects the most appropriate change to the attribute information that brings the design object closer to compliance with defined requirements. This change is then considered a viable mutation. Mutations are generated by the arrangement engine based on the current state of the robotic element, its environment and the actionable metadata.

### Integrated Human/Robotic Co-Learning Systems

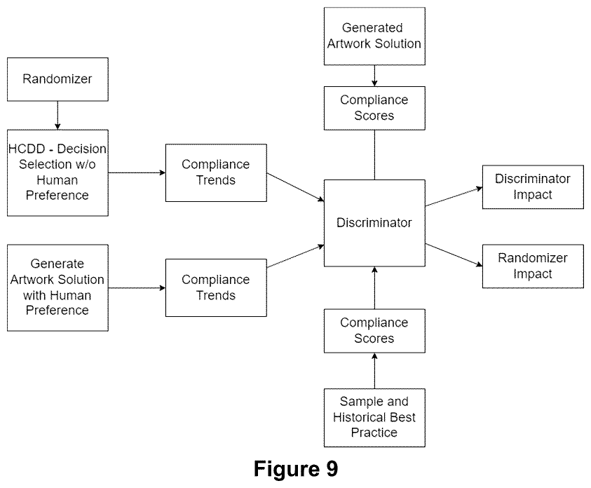

In some embodiments, the system and method may utilise an integrated human/robotic co-learning (HRCL) system. The HRCL is an integrated human-robotic co-learning system, which combines preferential decisions by a user with system solutions learning by the RGOE. FIG. 9 shows the approach of the HRCL system which follows a generative adversarial network (GAN) machine learning approach. Desired end outputs are driven by human selections and preferences. Given a set of options, a user will determine which solution for the design object is the “best” or most optimal. The same data set can then be utilised to generate new results. The core learning path of the HCRL is that the system learns the best decisions for reaching compliance more quickly based on results generated from non-human assisted decisions vs human-assisted decisions. RGOE additionally adds two additional sets of information to improve the decision complexity.

### Advantages

The invention described herein provides a number of unique technical advantages. The system provides the major benefit of reducing and eliminating human error via automated arrangement of elements and other features including, but not limited to, those detailed below. It also enables the realisation of multiple arrangements and/or solution options in the generation of design objects. The audit trail provided by the system allows for improved understanding of the steps and decisions in the arrangement of the robotic elements due to the traceability and accountability of decisions by both users and the arrangement engine.

Additional technical advantages lie in providing a common context-driven language (the actionable metadata or AAML), allowing a decision-making system to make more human-like decisions. AAML also enables machine learning transformation of other/future control parameters into actionable metadata.

Other technical advantages of the system and method for providing automated arrangement of robotic elements include, but are not limited to:
more easily identify and extract information through utilising tokenisation of keywords in the codex, and also allowing natural language of input files to translated into usable data;
early identification of deficiencies in control parameters and attribute data early in the process to minimise unnecessary processing and wastage of computer resources when generating the design object;
reducing the impact of unnecessary information and noise for each of the robotic elements, and increasing the efficiency with which the elements are able to perform decision-making and take actions to mutate for optimal arrangement by applying only actionable metadata required for the elements to be context-aware; and
the ability to mutate a plurality of attributes and characteristics of an individual robotic element at the same time, and the ability to mutate a plurality of robotic elements simultaneously to increase speed and efficiency of autonomous arrangement and design object generation.

On the basis of the above technical advantages provided by the technical features of the system and method, the automated arrangement of robotic elements results in effects which include, but are not limited to:
providing learned design object solutions that do not require templates;
simplifying design object variations;
improving the throughput in a supply chain from initialisation to end product, and simplifying the finishing process through outputting compliant design objects that are ready for use; and
reducing human resources, (including the time it takes to obtain approvals, make decisions, learn requirements, adjust individual elements of a design and the like), and substantially eliminating the burdensome and time-consuming process of individually determining the necessary elements and associated data.

### Other Uses

The invention is generally described with reference to a design system that implements control parameter codification and automated design assembly through automated arrangement of robotic elements. Systems and implementations described herein are only some examples of how such systems and methods could be used. However, it will be appreciated that these examples should not limit the scope of the invention and its application in other fields.

The system and method are implementable in the creation of regulatory, brand, production and design compliant design objects for packaging and labelling of products. However, it will be appreciated that the system and method can be used in the context of all kinds of design objects and document systems.

Alternative embodiments of the system and method described herein may be used in a variety of other fields. For example, the system and method may be used for automated website design, and design of brochures, pamphlets and/or presentation material. It may be used for a wide variety of packaging and labelling of any products, within or outside highly regulated industries. Embodiments of the system and method may be used in generating advertisement material, either printed or digital, media designs (such as magazine layouts, book covers). It may be used to generate design objects for graphical user interfaces or applications.

Beyond design, the same system, allowing robotic elements to know how to autonomously arrange themselves in a given play area while arranging themselves in a contextually correct manner in another, can be utilised with actual industrial robots for contextual behavioural movements and positioning when placed in different environments and with different players in their vicinity. Further, its use in security systems is viable. The system allows behaviour change, given an external stressor or source of information. This context driven action that happens autonomously, given a change in information, can be the basis for a security system that changes when faced with non-identified data/information requests for actions. The robotic elements in the system can then change their behaviour, allowing for an autonomously shifting security system,

Although the invention has been described with reference to specific examples it will be appreciated by those skilled in the art that the invention may be embodied in many other forms.

1. A method for generating a design object compliant with a set of predefined requirements, including:
extracting initialisation data from at least one data source;
extracting and parsing data from at least one database to define control data, wherein the at least one database includes the set of predefined requirements;
generating actionable metadata from the initialisation data and the control data;
determining a plurality of object components from the initialisation data;
generating a plurality of robotic elements corresponding to a respective one of the plurality of object components, the plurality of robotic elements each having respective attribute data;
identifying actionable metadata that applies to each of the plurality of robotic elements; and
respectively applying the actionable metadata to each of the plurality of robotic elements;
wherein the actionable metadata for each of the plurality of robotic elements enables each one of the plurality of robotic elements to be context-aware and establish communication with at least one related other of the plurality of robotic elements within a prescribed area of the design object, such that each of the plurality of robotic elements is autonomously arranged with respect to each other of the plurality of robotic elements within the prescribed area based on the respective actionable metadata and attribute data, thereby to generate the design object compliant with the set of predefined requirements.

2. (canceled)

3. (canceled)

4. (canceled)

5. A method according to claim 1, wherein the prescribed area is defined by a substantially polygon shape.

6. A method according to claim 1, wherein generating actionable metadata includes combining and transforming the initialisation data and control data into a common transformational language.

7. A method according to claim 1, further including the step of determining a manifest of each of the plurality of robotic elements.

8. A method according to claim 1, wherein the control data includes control parameters and/or constraints relating to the design object or at least one of the plurality of robotic elements.

9. A method according to claim 1, wherein the control data includes at least one of relational data, hierarchy data, regulatory data, rules data, guideline data, historical data, and previous selection data.

10. A method according to claim 1, wherein the actionable metadata includes a plurality of actionable metadata points.

11. A method according to claim 1, wherein at least part of the attribute data is formed from the initialisation data.

12. A method according to claim 1, further including the step of extracting historical data from a historical database, and including the historical data in the actionable metadata, such that each of the plurality of robotic elements are arranged based on the historical data.

13. (canceled)

14. A method according to any claim 1, wherein generating the design object includes selecting an optimal arrangement of the plurality of robotic elements.

15. (canceled)

16. (canceled)

17. (canceled)

18. A method according to claim 1, wherein attribute data includes at least one of characteristic data, behaviour data, environment data and context data.

19. (canceled)

20. A method according to claim 1, wherein each of the plurality of robotic elements is configured to reside within the boundaries of one or more prescribed areas.

21. A method according claim 1, wherein each of robotic elements is configured to replicate itself in one or more prescribed areas.

22. A method according to claim 1, wherein at least one of the plurality of robotic elements is configured to communicate with at least one other prescribed area.

23. A method according to claim 1, wherein each of the plurality of robotic elements includes relational information to enable self-arrangement.

24. A method according to claim 23 wherein the relational information includes at least one of hierarchical and/or prioritisation information upon which autonomous arrangement is executed.

25. A method according to claim 1, wherein the at least one of the plurality of robotic elements is configured to arrange itself into a localised decision group with at least a second of the plurality of robotic elements for self-arrangement.

26. A method according to an claim 1, wherein each of the plurality of robotic elements is configured to perform mutations to enable self-arrangement within the prescribed area.

27. A method according to claim 26 wherein mutations are performed based on at least a portion of the actionable metadata.

28. A system for generating a design object compliant with a set of predefined requirements, including:
at least one data source from which initialisation data is extracted;
at least one database including the set of predefined requirements;
an extraction unit, configured to extract and parse data from the at least one database to define control data;
a metadata unit in communication with the at least one database and the at least one data source, configured to generate actionable metadata from the initialisation data and the control data;
an element creation engine, configured to determine a plurality of object components from the initialisation data and generate a plurality of robotic elements each corresponding to a respective one of the plurality of object components, the plurality of robotic elements each having respective attribute data;
wherein the metadata unit is configured to identify the actionable metadata that applies to each of the plurality of robotic elements, and respectively apply said actionable metadata to each of the plurality of robotic elements, wherein the actionable metadata for each of the plurality of robotic elements enables each one of the plurality of robotic elements to be context-aware and establish communication with at least one related other of the plurality of robotic elements within a prescribed area of the design object; and
an arrangement engine in communication with each of plurality of robotic elements, and configured to enable each of the plurality of robotic elements to arrange itself autonomously with respect to each other of the plurality of robotic elements within the prescribed area based on the respective actionable metadata and attribute data; and
an object generation engine, configured to generate the design object compliant with the set of predefined requirements after arrangement of each of the a plurality of robotic elements.
